(19) United States
(12) Patent Application Publication
(10) Pub. No.: US 2016/0372737 A1
(43) Pub. Date: Dec. 22, 2016

(54) ELECTRODE MATERIAL AND BATTERY

(71) Applicant: Panasonic Intellectual Property Management Co., Ltd., Osaka (JP)

(72) Inventors: AKIRA KANO, Osaka (JP); SHUJI ITO, Nara (JP)

(21) Appl. No.: 15/181,433

(22) Filed: Jun. 14, 2016

(30) Foreign Application Priority Data
Jun. 18, 2015 (JP) 2015-122871

(51) Int. Cl. H01M 4/133; H01M 4/04; H01M 4/583; H01M 10/0525

(52) U.S. Cl. CPC H01M 4/133; H01M 10/0525; H01M 4/0471; H01M 4/583; H01M 2004/027

(57) ABSTRACT

An electrode material contains a carbon material. The carbon material has a specific surface area of 2 m²/g or more and 250 m²/g or less. The carbon material has a density, which is measured with a helium pycnometer, of 0.2 g/cc or more and 1.5 g/cc or less. A battery includes a negative electrode containing an electrode material, a positive electrode, and an electrolyte. The electrode material contains a carbon material. The carbon material has a specific surface area of 2 m²/g or more and 250 m²/g or less. The carbon material has a density, which is measured with a helium pycnometer, of 0.2 g/cc or more and 1.5 g/cc or less.

### BACKGROUND

### 1. Technical Field

The present disclosure relates to battery electrode materials and batteries.

### 2. Description of the Related Art

In Japanese Unexamined Patent Application Publication No. 2001-85005, there has been disclosed a lithium secondary battery in which an activated carbon having a minimum pore diameter of 5 Å to 16 Å and having a specific surface area of 960 m²/g to 2000 m²/g is used as a negative electrode current collector.

### SUMMARY

In the related art, there is a need to provide batteries having a high charge/discharge efficiency.

In one general aspect, the techniques disclosed here feature an electrode material containing a carbon material. The carbon material has a specific surface area of 2 m²/g or more and 250 m²/g or less. The carbon material has a density, which is measured with a helium pycnometer, of 0.2 g/cc or more and 1.5 g/cc or less. In one general aspect, the techniques disclosed here feature a battery including a negative electrode containing the above-mentioned electrode material, a positive electrode, and an electrolyte.

The present disclosure provides a battery having a high charge/discharge efficiency.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view illustrating the schematic configuration of a battery, which is an example battery in a second embodiment; and

FIG. 2 is a graph illustrating the relationship between the density of carbon materials and the charge/discharge efficiency in the tenth cycle for cells for evaluation in Examples 1 to 8 and Comparative Examples 1, 3, and 4.

### DETAILED DESCRIPTION

Embodiments of the present disclosure will be described below.

First, the viewpoints of the inventor will be described below.

Alkali metal ions in an electrolyte solution are present in the form of ions solvated by a solvent constituting the electrolyte solution. When these ions are desolvated from the electrolyte solution, the ions are reduced and deposited. Because of such deposition of the ions, side reactions are caused as a result of contact between the deposited alkali metal and the electrolyte solution.

When an activated carbon having a large specific surface area is used as in, for example, Japanese Unexamined Patent Application Publication No. 2001-85005, there are a large number of contact points between an electrolyte solution and surface parts of a negative electrode current collector other than pore parts. Thus, it is essentially difficult to deposit lithium only in the pores. Because of such difficulty, side reactions occur between the electrolyte solution and lithium deposited in parts other than the pore parts. As a result, the charge/discharge efficiency of the battery as disclosed in Japanese Unexamined Patent Application Publication No. 2001-85005 is low (for example, 20% or less) particularly in the first charging/discharging (in the first cycle).

The inventor has realized a configuration according to the present disclosure on the basis of the above-described viewpoints.

### First Embodiment

An electrode material according to a first embodiment contains a carbon material.

The carbon material has a specific surface area of 2 m²/g or more and 250 m²/g or less.

The carbon material has a density, which is measured with a helium pycnometer, of 0.2 g/cc or more and 1.5 g/cc or less.

According to the above configuration, a battery having a large charge/discharge capacity density and having a high charge/discharge efficiency is obtained.

The carbon material according to the first embodiment is characterized by a porous structure. In the carbon material according to the first embodiment, solvated alkali metal ions are desolvated before entering pores of the porous structure. The desolvated alkali metal ions are electrochemically deposited only in the internal spaces of the pores. Such deposition prevents or decreases contact between the electrolyte solution and the deposited active alkali metal. Consequently, this suppresses side reactions caused as a result of contact between the electrolyte solution and the alkali metal, such as oxidation and inactivation (deactivation) of part of the alkali metal due to the electrolyte solution.

Examples of the pores present in an electrode include pores present inside the current collector, pores present inside particles contained in the electrode, and pores present between the particles. Of these pores, pores that allow desolvation of alkali metal ions when the alkali metal ions enter the pores are, for example, closed pores which are present inside particles and are inaccessible to a solvent. The alkali metal deposited (charged) inside such closed pores does not come into contact with the electrolyte solution. This suppresses the above-described side reactions.

In the density measurement with a helium pycnometer, the density is measured with an ultrapycnometer by using helium atoms having an atomic radius of about 0.3 nm as a measuring gas. In this case, the atomic radius of lithium is about 0.2 nm. The diameter of Li ions solvated by propylene polycarbonate is about 0.6 nm (calculated by the Stokes method). In consideration of these, the density of the carbon material measured with a helium pycnometer is a density (g/cc) obtained by dividing the mass (g) of the carbon material by the total volume (cc) of the carbon material and the closed pores which are inaccessible to the electrolyte solution. Therefore, a low density of the carbon material measured with a helium pycnometer means that the carbon material contains many closed pores.

When the density of the carbon material measured with a helium pycnometer is 1.5 g/cc or less, closed pores that can sufficiently hold the alkali metal inside can be formed.

According to the above configuration, the solvated alkali metal ions can be desolvated before entering the pores of the porous structure, and the alkali metal can be deposited in the closed pores which are inaccessible to the electrolyte solution.

For this reason, deposition of the alkali metal on the surface of the electrode (for example, negative electrode) is suppressed in the first cycle and even in the case of an increased number of cycles by using the carbon material according to the first embodiment. This can suppress deterioration of the charge/discharge capacity density and deterioration of the charge/discharge efficiency.

When the density of the carbon material measured with a helium pycnometer is less than 0.2 g/cc, it may be difficult to produce an electrode that can be physically maintained.

When the specific surface area of the carbon material is less than 2 m²/g, the reaction surface area is too small. Thus, favorable charging/discharging reactions may not proceed when the specific surface area of the carbon material is less than 2 m²/g.

When the specific surface area is more than 250 m²/g, the side reactions may further proceed as a result of deposition of the alkali metal on the surface of the electrode.

The specific surface area of the carbon material can be obtained as follows: for example, the amount of gas adsorbed by the porous carbon material is measured with a fully automatic gas-adsorption measuring device by using nitrogen, and the specific surface area is determined by the BET multipoint method.

In the electrode material according to the first embodiment, the specific surface area of the carbon material may be 2 m²/g or more and 221 m²/g or less.

In the electrode material according to the first embodiment, the density of the carbon material measured with a helium pycnometer may be 0.2 g/cc or more and 1.43 g/cc or less.

According to the above configuration, a battery having a high charge/discharge capacity density and having a high charge/discharge efficiency is obtained.

In the electrode material according to the first embodiment, the specific surface area of the carbon material may be 2 m²/g or more and 100 m²/g or less.

According to the above configuration, the side reactions can be further suppressed by setting the specific surface area to 100 m²/g or less.

In the electrode material according to the first embodiment, the specific surface area of the carbon material may be 2 m²/g or more and 51 m²/g or less.

According to the above configuration, the side reactions can be further suppressed by setting the specific surface area to 51 m²/g or less.

In the electrode material according to the first embodiment, the total pore volume of the carbon material may be 0.01 cc/g or more and 0.1 cc/g or less.

When the total pore volume is 0.1 cc/g or more, there may be a large amount of the alkali metal deposited in the pores other than the closed pores. As a result, side reactions may occur between the electrolyte solution and the alkali metal deposited in the pores other than the closed pores.

The total pore volume can be calculated from the amount of gas adsorbed at a relative pressure of 0.99. The amount of gas is measured with a fully automatic gas-adsorption measuring device by using nitrogen gas as an adsorption gas. The fully automatic gas-adsorption measuring device is used as a device for determining the total pore volume (cc/g). The atomic radius of nitrogen atoms is about 0.4 nm. That is, the gas does not adsorb to the closed pores in this measurement. Therefore, this measurement can determine the volume of pores, which are called open pores, other than the closed pores.

In the electrode material according to the first embodiment, the total pore volume of the carbon material may be 0.02 cc/g or more and 0.09 cc/g or less.

According to the above configuration, a battery having a high charge/discharge capacity density and having a high charge/discharge efficiency is obtained.

### Method for Producing Carbon Material

The carbon material contained in the electrode material according to the first embodiment can be produced by, for example, firing an organic material or a porous carbon material, which serves as a carbon source, in an inert atmosphere.

The organic material serving as a carbon source may be a cellulose-based resin. The cellulose-based resin may be in the form of a sheet, a fiber, particles, or the like. From the viewpoint of processing after firing, the cellulose-based resin is preferably in the form of particles having a size of several micrometers to several tens of micrometers or in the form of a short fiber. Examples of inexpensive cellulose-based materials include charcoal, sawdust, and paper. The temperature of the heat treatment is preferably 1500° C. to 2100° C. An inert gas, such as nitrogen, argon, helium, or neon gas, may be preferably used as a firing atmosphere. The heat treatment allows elements other than carbon to evaporate from a raw material used as a carbon source and accordingly causes carbonization of the raw material. At the same time, the open pores can be closed and converted into closed pores.

The porous carbon material may be an activated carbon material or conductive carbon black. The activated carbon material or conductive carbon black may be in the form of a sheet, a fiber, particles, or the like. From the viewpoint of processing after firing, the activated carbon material or conductive carbon black is preferably in the form of particles having a size of several micrometers to several tens of micrometers or in the form of a short fiber. Examples of inexpensive activated carbon materials include steam-activated carbons. The temperature of the heat treatment is preferably 2100° C. to 2400° C. An inert gas, such as nitrogen, argon, helium, or neon gas, may be preferably used as a firing atmosphere. In general, an activated carbon material or conductive carbon black has many open pores and few closed pores. The open pores can be closed by the above-described firing and converted into closed pores.

When the carbon material needs to be pulverized into particles, the organic material or porous carbon material is preferably pulverized before the heat treatment. When the porous carbon material obtained by the heat treatment is pulverized, the structure of the porous carbon material may change, and closed pores may be convert into open pores or the like which are accessible to a solvent.

As described above, a method for producing a carbon material in one aspect in the first embodiment includes a step of providing an organic material or porous carbon material serving as a carbon source, and a step of heat-treating the organic material or porous carbon material in an inert atmosphere.

In the method for producing a carbon material in one aspect in the first embodiment, the organic material is a cellulose-based resin. In this case, the temperature of the heat treatment is 1500° C. or more and 2100° C. or less.

In the method for producing a carbon material in one aspect in the first embodiment, the porous carbon material is an activated carbon material or conductive carbon black. In this case, the temperature of the heat treatment is 2100° C. or more and 2400° C. or less.

### Second Embodiment

A second embodiment will be described below. The same descriptions as those in the first embodiment described above are appropriately omitted.

A battery according to the second embodiment includes a negative electrode, a positive electrode, and an electrolyte.

The negative electrode contains the electrode material according to the first embodiment described above.

According to the above configuration, a battery having a high charge/discharge capacity density and having a high charge/discharge efficiency is obtained.

In the battery according to the second embodiment, the negative electrode may contain the carbon material according to the first embodiment as a main component. That is, the negative electrode may contain, for example, 50% or more of the carbon material according to the first embodiment based on the total weight of the negative electrode.

According to the above configuration, a battery having a higher charge/discharge capacity density and having a higher charge/discharge efficiency is obtained.

In the battery according to the second embodiment, the positive electrode may be an electrode that has a property of occluding and releasing one or more alkali metal ions (e.g., an electrode that can intercalate and deintercalate one or more alkali metal ions).

In the battery according to the second embodiment, the electrolyte may be an electrolyte containing alkali metal ions.

The battery according to the second embodiment may be constructed as a lithium secondary battery.

In the battery according to the second embodiment, the alkali metal ions may be lithium ions.

When the battery according to the second embodiment is in a charged state, the potential of the negative electrode with respect to a reference electrode of an alkali metal may be 0 V or less.

According to the above configuration, the alkali metal is present in pores when the potential of the negative electrode with respect to the reference electrode of the alkali metal is 0 V or less.

When a black lead is used as a negative electrode and the potential of the negative electrode with respect to the reference electrode is 0 V or less, a battery internal short circuit or side reactions between an alkali metal and an electrolyte solution may be caused as a result of deposition of the alkali metal on the surface of the negative electrode.

In contrast, when the potential of the negative electrode with respect to the reference electrode is 0 V or less in the battery according to the second embodiment, the alkali metal is preferentially deposited in the pores. This can suppress a battery internal short circuit and also can suppress side reactions between the deposited alkali metal and the electrolyte solution. As a result, deterioration of the charge/discharge efficiency can be suppressed.

The alkali metal deposited in the pores is dissolved in the electrolyte again during discharging. The alkali metal is then dispersed as alkali metal ions in the electrolyte and intercalated again into the positive electrode active material. This phenomenon is reversible. Even if charging and discharging are repeated several times, deposition of the alkali metal in the pores and dissolution of the alkali metal in the electrolyte are repeated.

The capacity of the battery can be accordingly increased by depositing the alkali metal ions in the pores and dissolving the alkali metal ions in the electrolyte solution again. That is, when a carbon material having a layered structure is used, the capacity results from intercalation and deintercalation of the alkali metal ions between the layers. The battery according to the second embodiment can involve deposition of the alkali metal in the pores in addition to intercalation and deintercalation of the alkali metal ions between the layers. Consequently, the battery according to the second embodiment provides a secondary battery having a large capacity.

When the battery according to the second embodiment is in a charged state, the end-of-charge voltage may be lower than the potential of the reference electrode of the alkali metal.

According to the above configuration, a battery having a large capacity is obtained while suppressing deterioration of the cycle characteristics of the battery.

In addition, a power storage system may be formed by using the battery according to the second embodiment.

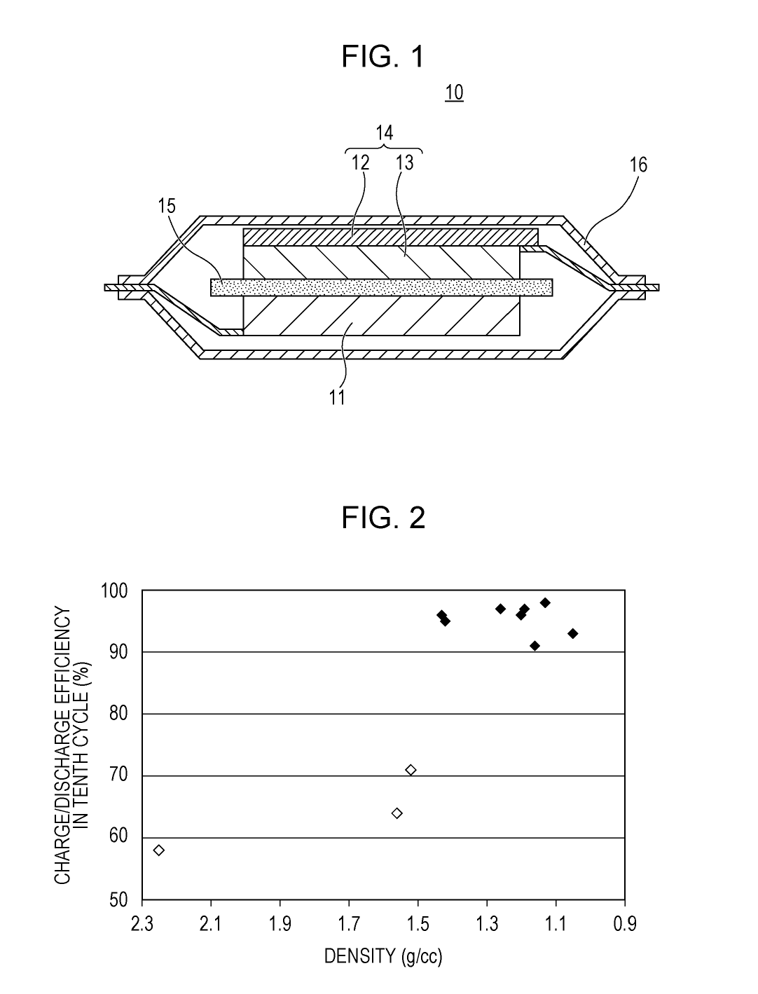

FIG. 1 is a cross-sectional view illustrating the schematic configuration of a battery 10, which is an example battery according to the second embodiment.

As illustrated in FIG. 1, the battery 10 includes a negative electrode 11, a positive electrode 14, a separator 15, and a case 16.

The positive electrode 14 includes a positive electrode current collector 12 and a positive electrode mixture layer 13 formed in contact with the positive electrode current collector 12.

The negative electrode 11 and the positive electrode 14 are disposed to oppose each other across the separator 15.

These components are placed in the case 16 to form the battery 10.

The negative electrode 11 contains the electrode material according to the first embodiment described above. For example, the negative electrode 11 may contain the electrode material according to the first embodiment described above as a negative electrode active material.

The negative electrode 11 may contain another negative electrode active material, a negative electrode current collector, and the like.

The negative electrode 11 may contain a conductive assistant, an ion conductor, a binder, and the like as desired.

The positive electrode mixture layer 13 contains a positive electrode active material that can intercalate and deintercalate alkali metal ions.

The positive electrode mixture layer 13 may contain a conductive assistant, an ion conductor, a binder, and the like as desired.

A material that can intercalate and deintercalate alkali metal ions may be used as the positive electrode active material. Examples of the positive electrode active material include alkali metal-containing transition metal oxides, transition metal fluorides, polyanion materials, fluorinated polyanion materials, and transition metal sulfides. Of these, alkali metal-containing transition metal oxides are preferably used because of inexpensive production costs and a high average discharge voltage.

As the positive electrode current collector 12, a porous or non-porous sheet or film formed of a metal material, such as aluminum, stainless steel, titanium, or an alloy thereof, can be used. Aluminum and an alloy thereof are preferred because they are inexpensive and easily formed into a thin film. As the sheet or film, a metal foil, a mesh, or the like may be used. A carbon material, such as carbon, may be applied to the surface of the positive electrode current collector 12 in order to decrease the resistance, impart a catalytic effect, and increase the bonding strength between the positive electrode mixture layer 13 and the positive electrode current collector 12 by chemical or physical bonding between the positive electrode mixture layer 13 and the positive electrode current collector 12.

The conductive assistant and the ion conductor may be used in order to decrease the electrode resistance.

Examples of the conductive assistant include graphites, such as natural graphite and artificial graphite; carbon blacks, such as acetylene black and ketjenblack; conductive fibers, such as carbon fibers and metal fibers; metal powders, such as fluorinated carbon powder and aluminum powder; conductive whiskers, such as that formed of zinc oxide and that formed of potassium titanate; conductive metal oxides, such as titanium oxide; and conductive polymer compounds, such as polyaniline, polypyrrole, and polythiophene. Of these, carbon conductive assistants are preferred because of low costs.

Examples of the ion conductor include gel electrolytes, such as polymethyl methacrylate; organic solid electrolytes, such as polyethylene oxide; and inorganic solid electrolytes, such as Li₇La₃Zr₂O₁₂.

The binder may be used in order to improve the bonding strength between materials contained in the electrode. Examples of the binder include polyvinylidene fluoride, polytetrafluoroethylene, polyethylene, polypropylene, aramid resin, polyimide, polyimide, polyamideimide, polyacrylnitrile, polyacrylic acid, poly(methyl acrylate), poly(ethyl acrylate), poly(hexyl acrylate), polymethacrylic acid, poly(methyl methacrylate), poly(ethyl methacrylate), poly(hexyl methacrylate), polyvinyl acetate, polyvinylpyrrolidone, polyether, polyethersulfone, hexafluoropolypropylene, styrene-butadiene rubber, and carboxymethyl cellulose. In addition, a copolymer of two or more materials selected from tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene may be used. These may be used in a mixture of two or more.

As the separator 15, a porous membrane formed of polyethylene, polypropylene, glass, cellulose, ceramics, or the like may be used. The separator 15 may be used while the pores in the separator 15 are filled with the electrolyte.

As the electrolyte, an electrolyte solution containing an alkali metal salt and a nonaqueous solvent, a gel electrolyte, a solid electrolyte, or the like may be used.

Examples of the alkali metal salt to be used include a lithium salt and a sodium salt.

Examples of the lithium salt to be used include lithium hexafluorophosphate (LiPF₆), lithium tetrafluoroborate (LiBF₄), lithium perchlorate (LiClO₄), lithium bis(trifluoromethylsulfonyl)imide (LiN(SO₂CF₃)₂), lithium bis(perfluoroethylsulfonyl)imide (LiN(SO₂C₂F₅)₂), lithium bis(fluoromethylsulfonyl)imide (LiN(SO₂F)₂), LiAsF₆, LiCF₃SO₃, and lithium difluoro(oxalato)borate. Of these, LiPF₆ is preferably used from the viewpoint of the safety and thermal stability of the battery and the ion conductivity in the battery. The electrolyte salts may be used alone or in combination of two or more.

Examples of the sodium salt to be used include sodium hexafluorophosphate (NaPF₆), sodium tetrafluoroborate (NaBF₄), sodium perchlorate (NaClO₄), sodium bis(trifluoromethylsulfonyl)imide (NaN(SO₂CF₃)₂), sodium bis(perfluoroethylsulfonyl)imide (NaN(SO₂C₂F₅)₂), sodium bis(fluoromethylsulfonyl)imide (NaN(SO₂F)₂), NaAsF₆, NaCF₃SO₃, and sodium difluoro(oxalato)borate. Of these, NaPF₆ is preferably used from the viewpoint of the safety and thermal stability of the battery and the ion conductivity in the battery. The electrolyte salts may be used alone or in combination of two or more.

Examples of the nonaqueous solvent to be used include cyclic carbonates, chain carbonates, esters, cyclic ethers, chain ethers, nitriles, and amides. These solvents may be used alone or in combination of two or more.

Examples of the cyclic carbonates include ethylene carbonate, propylene carbonate, and butylene carbonate. The hydrogen groups of the cyclic carbonates may be partially fluorinated or entirely fluorinated. Examples include trifluoropropylene carbonate and fluoroethyl carbonate.

Examples of the chain carbonates include dimethyl carbonate, ethyl methyl carbonate, diethyl carbonate, methyl propyl carbonate, ethyl propyl carbonate, and methyl isopropyl carbonate. The hydrogen groups of the chain carbonates may be partially fluorinated or entirely fluorinated.

Examples of the esters include methyl acetate, ethyl acetate, propyl acetate, methyl propionate, ethyl propionate, and γ-butyrolactone.

Examples of the cyclic ethers include 1,3-dioxolane, 4-methyl-1,3-dioxolane, tetrahydrofuran, 2-methyltetrahydrofuran, propylene oxide, 1,2-butyleneoxide, 1,4-dioxane, 1,3,5-trioxane, furan, 2-methylfuran, 1,8-cineole, and crown ether.

Examples of the chain ethers include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxy toluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl.

Examples of the nitriles include acetonitrile.

Examples of the amides include dimethylformamide.

### EXAMPLES

Examples described below are for illustrative purposes only, and the present disclosure is not limited only to Examples described below.

### Example 1

### Production of Carbon Material

A carbon material was produced by the following three steps: a carbonization step, a classification step, and a heat treatment step.

First, the carbonization step will be described. As a carbon source, α-cellulose (Whatman quantitative filter paper No. 40) was used. This α-cellulose was heated in a tube furnace with an Ar atmosphere (Ar gas flow rate: 1 L/min) at a heating rate of 10° C./min from room temperature to 1000° C. and was maintained at 1000° C. for 1 hour. Subsequently, the heating was stopped, and a carbide was allowed to cool and then taken out of the tube furnace.

Next, the classification step will be described. The carbide obtained in the carbonization step was pulverized with an agate mortar. The resultant product was classified by using a standard sieve having a mesh size of 40 μm and made of SUS. This classification provided a carbon powder.

Finally, the heat treatment step will be described. The carbon powder described above was heated in a tube furnace with an Ar atmosphere (Ar gas flow rate: 1 L/min) at a heating rate of 10° C./min from room temperature to 1500° C. and was maintained at 1500° C. for 1 hour. That is, the temperature of the heat treatment step (heat treatment temperature) in Example 1 was 1500° C. Subsequently, the heating was stopped, and a carbon material was allowed to cool and then taken out of the tube furnace.

The carbon material was obtained as described above.

### Production of Test Electrode

The obtained carbon material and a binding agent, polyvinylidene fluoride, were weighed out in a weight ratio of 9:1.

These were dispersed in a NMP solvent to form a slurry.

The prepared slurry was applied to a Cu current collector by using a coater.

The coated electrode plate was rolled with a rolling mill and punched out in the form of a square having sides of 20 mm.

The obtained electrode plate was processed in the form of an electrode to provide a test electrode.

### Production of Cell for Evaluation

A lithium secondary battery (cell for evaluation) in which lithium was used as a counter electrode and a reference electrode was produced by using the test electrode described above.

Preparation of an electrolyte solution and production of the cell for evaluation were performed in a glovebox with an Ar atmosphere having a dew point of −60 degrees or less and an oxygen value of 1 ppm or less.

A 1 molar solution of lithium hexafluorophosphate (LiPF₆) in a 1:1 (volume ratio) mixed solvent of ethylene carbonate and diethyl carbonate was used as an electrolyte solution.

Lithium was pressure-bonded to a square nickel mesh having sides of 20 mm. This was used as a counter electrode.

The test electrode and the counter electrode were allowed to oppose each other across a separator. The separator is a polyethylene microporous membrane impregnated with the electrolyte solution. In this state, these components are placed in a case, and the case is sealed.

The cell for evaluation was obtained as described above.

### Example 2

The temperature of the heat treatment step (heat treatment temperature) was 2100° C.

A carbon material was produced by the same method as in Example 1 described above except the temperature of the heat treatment step.

In addition, a test electrode and a cell for evaluation were produced by the same methods as in Example 1 described above.

### Example 3

An activated carbon material (specific surface area: 1900 m²/g; average particle size: 20 μm) was used as a carbon source for a carbon material.

The temperature of the heat treatment step (heat treatment temperature) was 2100° C.

A carbon material was produced by the same method as in Example 1 described above except the carbon source and the temperature of the heat treatment step.

In addition, a test electrode and a cell for evaluation were produced by the same methods as in Example 1 described above.

### Example 4

An activated carbon material (specific surface area: 2500 m²/g; average particle size: 9 μm) was used as a carbon source for a carbon material.

The temperature of the heat treatment step (heat treatment temperature) was 2400° C.

A carbon material was produced by the same method as in Example 1 described above except the carbon source and the temperature of the heat treatment step.

In addition, a test electrode and a cell for evaluation were produced by the same methods as in Example 1 described above.

### Example 5

An activated carbon material (specific surface area: 2000 m²/g; average particle size: 8 μm) was used as a carbon source for a carbon material.

The temperature of the heat treatment step (heat treatment temperature) was 2400° C.

A carbon material was produced by the same method as in Example 1 described above except the carbon source and the temperature of the heat treatment step.

In addition, a test electrode and a cell for evaluation were produced by the same methods as in Example 1 described above.

### Example 6

An activated carbon material (specific surface area: 1600 m²/g; average particle size: 6 μm) was used as a carbon source for a carbon material.

The temperature of the heat treatment step (heat treatment temperature) was 2400° C.

A carbon material was produced by the same method as in Example 1 described above except the carbon source and the temperature of the heat treatment step.

In addition, a test electrode and a cell for evaluation were produced by the same methods as in Example 1 described above.

### Example 7

Ketjenblack (EC600, available from Lion Specialty Chemicals Co., Ltd.) was used as a carbon source for a carbon material.

The temperature of the heat treatment step (heat treatment temperature) was 2100° C.

A carbon material was produced by the same method as in Example 1 described above except the carbon source and the temperature of the heat treatment step.

In addition, a test electrode and a cell for evaluation were produced by the same methods as in Example 1 described above.

### Example 8

The temperature of the heat treatment step (heat treatment temperature) was 2400° C.

A carbon material was produced by the same method as in Example 7 described above except the temperature of the heat treatment step.

In addition, a test electrode and a cell for evaluation were produced by the same methods as in Example 7 described above.

### Comparative Example 1

A graphite carbon material (NG12) was used as a carbon material.

In addition, a test electrode and a cell for evaluation were produced by the same methods as in Example 1 described above.

### Comparative Example 2

The temperature of the heat treatment step (heat treatment temperature) was 1000° C.

A carbon material was produced by the same method as in Example 1 described above except the temperature of the heat treatment step.

In addition, a test electrode and a cell for evaluation were produced by the same methods as in Example 1 described above.

### Comparative Example 3

The temperature of the heat treatment step (heat treatment temperature) was 1800° C.

A carbon material was produced by the same method as in Example 4 described above except the temperature of the heat treatment step.

In addition, a test electrode and a cell for evaluation were produced by the same methods as in Example 4 described above.

### Comparative Example 4

An activated carbon material (specific surface area: 2000 m²/g; average particle size: 2 μm) was used as a carbon source for a carbon material.

The temperature of the heat treatment step (heat treatment temperature) was 2600° C.

A carbon material was produced by the same method as in Example 1 described above except the carbon source and the temperature of the heat treatment step.

In addition, a test electrode and a cell for evaluation were produced by the same methods as in Example 1 described above.

### Comparative Example 5

The temperature of the heat treatment step (heat treatment temperature) was 1500° C.

A carbon material was produced by the same method as in Example 3 described above except the temperature of the heat treatment step.

In addition, a test electrode and a cell for evaluation were produced by the same methods as in Example 3 described above.

### Comparative Example 6

The temperature of the heat treatment step (heat treatment temperature) was 1800° C.

A carbon material was produced by the same method as in Example 3 described above except the temperature of the heat treatment step.

In addition, a test electrode and a cell for evaluation were produced by the same methods as in Example 3 described above.

### Comparative Example 7

The temperature of the heat treatment step (heat treatment temperature) was 1800° C.

A carbon material was produced by the same method as in Example 7 described above except the temperature of the heat treatment step.

In addition, a test electrode and a cell for evaluation were produced by the same methods as in Example 7 described above.

### Measurement of Density, Specific Surface Area, and Total Pore Volume

The carbon materials according to Examples 1 to 8 and Comparative Examples 1 to 7 were measured for their density, specific surface area, and total pore volume.

The density of the carbon material was measured with an ultrapycnometer (Ultrapyc 1200e available from Quantachrome Instruments Japan G.K.) using helium as a measuring gas.

The amount of gas adsorbed by the porous carbon material was measured with a fully automatic gas-adsorption measuring device (AS1-MP-9 available from Quantachrome Instruments Japan G.K.) using nitrogen. The specific surface area of the carbon material was determined by the BET multipoint method.

The total pore volume of the carbon material was calculated from the amount of gas adsorbed at a relative pressure of 0.99.

### Charge/Discharge Test

The cells for evaluation according to Examples 1 to 8 and Comparative Examples 1 to 7 were evaluated for their charge/discharge characteristics in a charge/discharge test.

The method of the charge/discharge test and the results will be described.

The charge/discharge test for the cells for evaluation was performed in a thermostatic bath at 25° C.

In the charge/discharge test, a test electrode was charged and then discharged after a 20-minute pause.

In charging/discharging, the test electrode was charged at a constant current of 15 mA per unit weight of the carbon material until the difference in potential between the test electrode and a reference electrode reached 0 V.

Subsequently, the test electrode was charged at a constant current of 15 mA for 20 hours, so that lithium was deposited in an amount corresponding to the amount at 300 mAh per unit weight of the carbon material.

The potential of the test electrode (working electrode) during deposition of lithium was 0 V or less with respect to lithium in the reference electrode.

The test electrode was then discharged until the difference in potential between the test electrode and the reference electrode reached 2 V. In this manner, the charge/discharge characteristics were investigated.

The charge/discharge efficiency (%) in the first cycle was calculated by dividing the discharge capacity in the first cycle by the charge capacity in the first cycle.

The charge/discharge efficiency (%) in the tenth cycle was calculated by dividing the discharge capacity in the tenth cycle by the charge capacity in the tenth cycle.

The results of the charge/discharge test for the cells for evaluation according to Examples 1 to 8 and Comparative Examples 1 to 7 are shown in Table together with the density, the specific surface area, and the total pore volume of the carbon materials.

TABLE

| | Measurement of | | | Charge/discharge test | |
|---|---|---|---|---|---|
| | carbon material | | | Charge/ | Charge/ |
| | | Specific | Total | discharge | discharge |
| | | surface | pore | efficiency in | efficiency in |
| | Density | area | volume | first cycle | tenth cycle |
| | g/cc | m²/g | cc/g | % | % |
| Example 1 | 1.43 | 2 | 0.02 | 83 | 96 |
| Example 2 | 1.42 | 3 | 0.02 | 88 | 95 |
| Example 3 | 1.26 | 51 | 0.09 | 82 | 97 |
| Example 4 | 1.13 | 7 | 0.03 | 86 | 98 |
| Example 5 | 1.20 | 23 | 0.09 | 84 | 96 |
| Example 6 | 1.19 | 11 | 0.05 | 82 | 97 |
| Example 7 | 1.16 | 221 | 1.41 | 80 | 91 |
| Example 8 | 1.05 | 17 | 1.50 | 83 | 93 |
| Comparative | 2.25 | 7 | 0.04 | 92 | 58 |
| Example 1 | | | | | |
| Comparative | 1.96 | 334 | 0.54 | 54 | 72 |
| Example 2 | | | | | |
| Comparative | 1.56 | 64 | 0.22 | 81 | 64 |
| Example 3 | | | | | |
| Comparative | 1.52 | 219 | 0.74 | 78 | 71 |
| Example 4 | | | | | |
| Comparative | 2.26 | 1258 | 1.62 | 13 | 86 |
| Example 5 | | | | | |
| Comparative | 1.90 | 484 | 0.73 | 14 | 86 |
| Example 6 | | | | | |
| Comparative | 1.18 | 269 | 1.76 | 61 | 84 |
| Example 7 | | | | | |
| Discussion | | | | | |

The results shown in Table indicate that the charge/discharge characteristics of the carbon material notably differed with the structure of the carbon material.

In Example 7, the density of the carbon material is as low as 1.16 g/cc.

Because of a low density, the carbon material of Example 7 contains many closed pores that can hold lithium inside.

Because of many closed pores, in Example 7, the charge/discharge efficiency in the first cycle is as high as 80%, and the charge/discharge efficiency in the tenth cycle is as high as 91%.

In Comparative Example 7, the density of the carbon material is 1.18 g/cc. The carbon material of Comparative Example 7 contains closed pores as many as those in the carbon material of Example 7.

In spite of this, in Comparative Example 7, the charge/discharge efficiency in the first cycle is as low as 61%, and the charge/discharge efficiency in the tenth cycle is as low as 84%.

In Comparative Example 7, the specific surface area of the carbon material is as large as 269 m²/g.

Because of a large specific surface area, the number of contact points between the electrolyte solution and surface parts other than closed pores is large. Such a large number of contact points probably make it difficult to deposit lithium only in the closed pores. As a result, it is impossible to sufficiently suppress side reactions between the electrolyte solution and lithium deposited in parts other than closed pores. Therefore, the charge/discharge efficiency is low although the carbon material contains many closed pores.

The above-described results indicate that the specific surface area of the carbon material is desirably 250 m²/g or less in order to obtain a high charge/discharge efficiency in the first cycle and a high charge/discharge efficiency in the tenth cycle.

In Examples 1 to 8 and Comparative Examples 1, 3, and 4, the specific surface area of the carbon materials is 250 m²/g or less.

FIG. 2 is a graph illustrating the relationship between the density of the carbon material and the charge/discharge efficiency (in the tenth cycle) of the cells for evaluation in Examples 1 to 8 and Comparative Examples 1, 3, and 4.

In all of Examples 1 to 8, the specific surface area of the carbon materials is 250 m²/g or less, and the density of the carbon materials measured with a helium pycnometer is 1.5 g/cc or less.

In all of Examples 1 to 8, the charge/discharge efficiency in the tenth cycle is 90% or more.

In Comparative Examples 1, 3, and 4, the specific surface area of the carbon materials is as small as 250 m²/g or less. Thus, the number of contact points between the surface parts and the electrolyte solution is small, which makes it possible to suppress side reactions therebetween. Therefore, the charge/discharge efficiency in the first cycle is 78% or more, which is a relatively high value.

However, in Comparative Examples 1, 3, and 4, the density of the carbon materials measured with a helium pycnometer is higher than 1.5 g/cc.

The amount of closed pores that can hold lithium inside is thus insufficient. Thus, lithium that cannot be held only in the closed pores is deposited on the surface parts. This deposition generates side reactions between lithium and the electrolyte solution, and the side reactions are repeated in each charge/discharge cycle. These repeated side reactions probably decrease the charge/discharge efficiency in the tenth cycle to 71% or less in all of Comparative Examples 1, 3, and 4.

The above-described results indicate that a charge/discharge efficiency higher than those of lithium batteries known in the related art and including lithium as a negative electrode can be obtained when the specific surface area of the carbon material is 250 m²/g or less, and the density of the carbon material measured with a helium pycnometer is 1.5 g/cc or less. That is, it is found that the charge/discharge efficiency in the first cycle can be 80% or more, and the charge/discharge efficiency in the tenth cycle can be 91% or more.

In Comparative Example 2, the specific surface area of the carbon material is as large as 250 m²/g or more. Because of a large specific surface area, the number of contact points with the electrolyte solution is large in Comparative Example 2.

In Comparative Example 2, the density of the carbon material measured with a helium pycnometer is as high as 1.5 g/cc or more. In Comparative Example 2, the amount of closed pores that can hold lithium inside is thus insufficient.

As a result, in Comparative Example 2, the charge/discharge efficiency in the first cycle is as low as 54%, and the charge/discharge efficiency in the tenth cycle is as low as 72%.

In Comparative Example 5, the specific surface area of the carbon material is 1258 m²/g.

In Comparative Example 6, the specific surface area of the carbon material is 484 m²/g.

When the specific surface area of the carbon material is significantly large in these examples, the number of contact points between the surface parts and the electrolyte solution is too large. With such a large number of contact points, the side reactions excessively proceed.

As a result, the charge/discharge efficiency in the first cycle in Comparative Example 5 is 13%, and the charge/discharge efficiency in the first cycle in Comparative Example 6 is 14%. These values are significantly small.

In Examples 1 to 6 and Example 8, the specific surface area of the carbon materials is 100 m²/g or less.

In all of Examples 1 to 6 and Example 8, the charge/discharge efficiency in the first cycle is as high as 82% or more, and the charge/discharge efficiency in the tenth cycle is as high as 93% or more.

In Examples 1 to 6, the total pore volume of the carbon material is 0.1 cc/g or less. Thus, the amount of lithium deposited in pores other than closed pores is small.

As a result, in all of Examples 1 to 6, the charge/discharge efficiency in the tenth cycle is 95% or more, which is a significant large value.

In the embodiments, the density of the carbon material may be as low as possible. For example, the density of the carbon material may be lower than 1.05 g/cc.

For example, the density of the carbon material can be decreased by appropriately selecting the heat treatment conditions under which the closed pores are formed.

In the embodiments, examples in which a test electrode is formed by using carbon particles as a carbon material are described. In the embodiments, a sheet-like carbon material having a carbon structure similar to that of the carbon particles may be used as a portion of a test electrode or a negative electrode current collector. In this case, similar charge/discharge characteristics can be obtained.

The electrode material of the present disclosure can be suitably used as an electrode material for batteries such as secondary batteries.

What is claimed is:

1. An electrode material comprising a carbon material,
wherein the carbon material has a specific surface area of 2 m²/g or more and 250 m²/g or less, and
the carbon material has a density, which is measured with a helium pycnometer, of 0.2 g/cc or more and 1.5 g/cc or less.

2. The electrode material according to claim 1,
wherein the carbon material has a specific surface area of 221 m²/g or less, and
the carbon material has a density, which is measured with a helium pycnometer, of 1.43 g/cc or less.

3. The electrode material according to claim 1,
wherein the carbon material has a specific surface area of 100 m²/g or less.

4. The electrode material according to claim 3,
wherein the carbon material has a specific surface area of 51 m²/g or less.

5. The electrode material according to claim 1,
wherein the carbon material has a total pore volume of 0.01 cc/g or more and 0.1 cc/g or less.

6. The electrode material according to claim 5,
wherein the carbon material has a total pore volume of 0.02 cc/g or more and 0.09 cc/g or less.

7. A battery comprising:
a negative electrode containing an electrode material;
a positive electrode; and
an electrolyte,
wherein the electrode material contains a carbon material,
the carbon material has a specific surface area of 2 m²/g or more and 250 m²/g or less, and
the carbon material has a density, which is measured with a helium pycnometer, of 0.2 g/cc or more and 1.5 g/cc or less.

8. The battery according to claim 7,
wherein the negative electrode contains the carbon material as a main component.

9. The battery according to claim 7,
wherein the positive electrode is an electrode that has a property of occluding and releasing an alkali metal ion, and
the electrolyte is an electrolyte containing the alkali metal ion.

10. The battery according to claim 9,
wherein the alkali metal ion is a lithium ion.

11. The battery according to claim 9,
wherein a potential of the negative electrode with respect to a reference electrode of an alkali metal is 0 V or less when the battery is in a charged state.

12. The battery according to claim 11,
wherein an end-of-charge voltage is lower than a potential of the reference electrode of the alkali metal when the battery is in a charged state.
